(19) United States
(12) Patent Application Publication
(10) Pub. No.: US 2011/0078294 A1
(43) Pub. Date: Mar. 31, 2011

(54) EMBEDDED ELECTRONIC DEVICE

(75) Inventors: LIANG-MAO HUNG, Tu-Cheng (TW); CHIH-YUAN CHUANG, Tu-Cheng (TW); CHIA-HUNG CHIEN, Tu-Cheng (TW)

(73) Assignee: HON HAI PRECISION INDUSTRY CO., LTD., Tu-Cheng (TW)

(21) Appl. No.: 12/647,728

(22) Filed: Dec. 28, 2009

(30) Foreign Application Priority Data
Sep. 29, 2009 (CN) 200910307909.0

(51) Int. Cl. G06F 15/173; G06F 15/177

(52) U.S. Cl. 709/222; 709/224

(57) ABSTRACT

An embedded electronic device includes a foreground application module, a system monitor module, and a network controller module. The system monitor module is configured to monitor the working status of network via the network controller. The system monitor module is configured to monitor the working status of network and is capable of sending the working status of the network to the system monitor module. The system monitor module is capable of sending the working status to the foreground application module.

This application is related to co-pending U.S. patent applications entitled “EMBEDDED ELECTRONIC DEVICE”, Attorney Docket No. US28687.

### BACKGROUND

1. Technical Field

The present disclosure relates to an embedded electronic device, and particularly, to an embedded electronic device with enhanced content.

2. Description of Related Art

Embedded electronic devices such as digital photo frames (DPF) are becoming increasingly popular due to the convenience and ease of function. However, the typical digital photo frame can only display photos. A digital photo frame with enhanced content is desirable.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a construction view of an embedded electronic device.

FIG. 2 is a schematic view of an embedded electronic device.

FIG. 3 is a schematic view of a main menu of the electronic device of FIG. 1.

FIG. 4 shows implementation of a foreground application in the electronic device of FIG. 1.

FIG. 5 shows termination of the foreground application of FIG. 4.

FIG. 6 is a schematic view of a system monitor module of an embedded electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

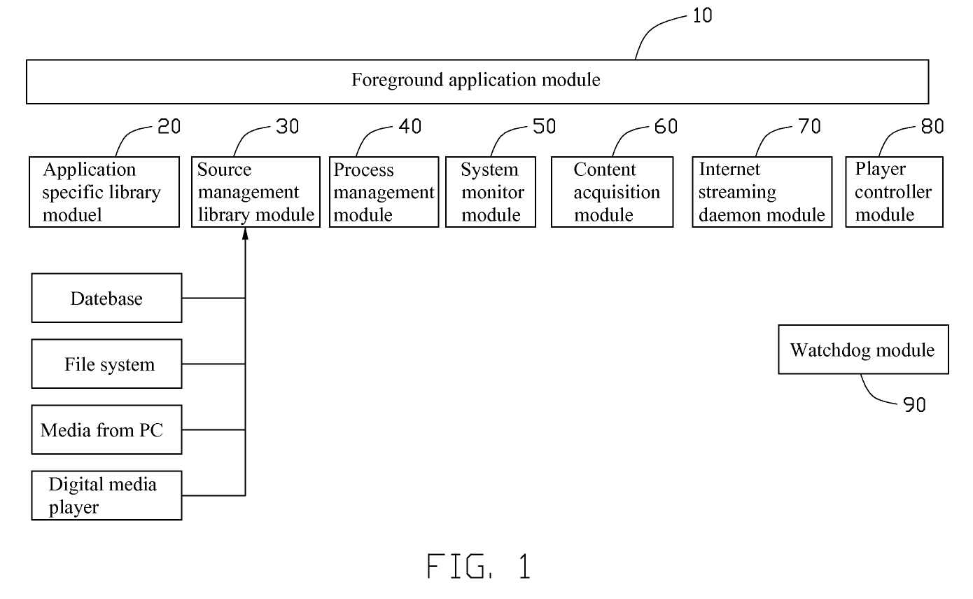

Referring to FIG. 1, an embedded electronic device 100 includes a foreground application module 10, an application specific library module 20, a source management library module 30, a process management module 40, a system monitor module 50, a content acquisition module 60, an internet streaming daemon module 70, a playback controller module 80, and a watchdog module 90. The foreground application module 10 includes a plurality of foreground applications. Each of the modules 10-90 is a standalone process to minimize the effect of individual failure thereof.

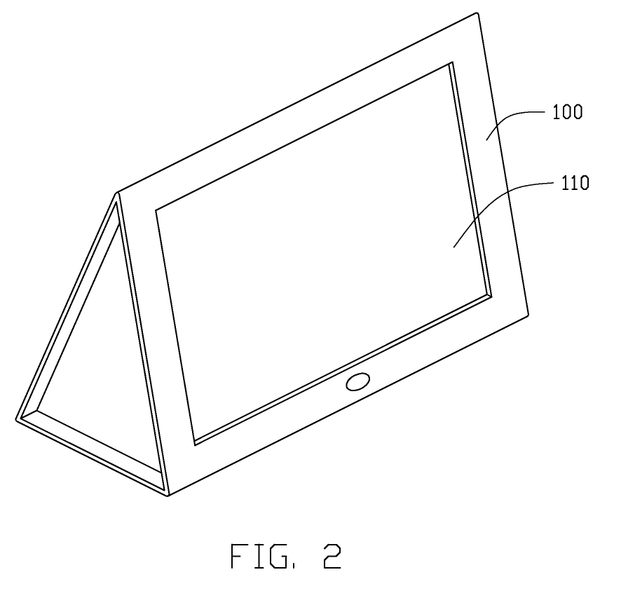

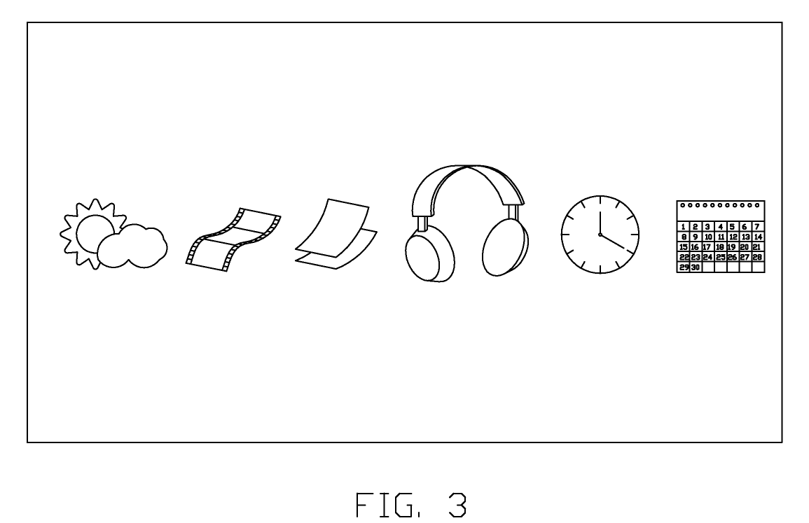

In one exemplary embodiment, and with reference to FIG. 2 and FIG. 3, the embedded electronic device 100 may be a digital photo frame. The embedded electronic device 100 includes a display 110 and a memory. One foreground application dominates the display 110 at a time. In FIG. 3, the display 110 shows a main menu. The main menu may include selections of weather, video, photo, music, calendar, and others. The embedded electronic device 100 also includes a data reader, for example, a secure digital memory (SD) card reader, a compact flash (CF) card reader, an extreme digital (XD) reader, but may also connect to external storage.

The application specific library module 20 hides specific details of a foreground application, such as network protocols of HTTP, awareness of which is not required. Operational commands are received by way of the user interface. The source manager library module 30 retrieves a variety of resources from a range of sources, such as a database, a file system, a personal computer, or a digital media player, and provides the resources to the foreground application module 10.

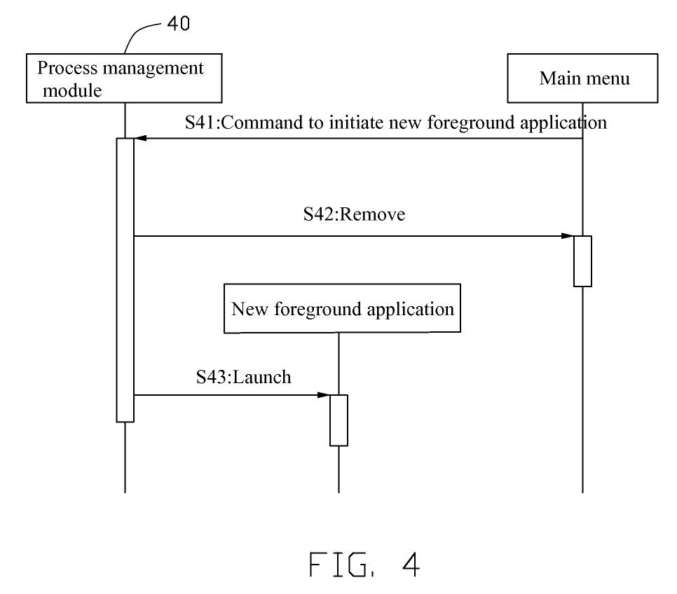

The process management module 40 switches foreground applications, such as launching a foreground application from a main menu displayed on the display 110, returning to the main menu from the foreground application, and/or starting a screen saver or alarm clock. Referring to FIG. 4, a process for launching a foreground application includes following steps.

In step S41, the main menu of the embedded electronic device 100 sends a command to the process management module 40 to initiate a new foreground application.

In step S42, the process management module 40 removes the main menu from view of the display 110.

In step S43, the process management module 40 launches the new foreground application on the embedded electronic device 100.

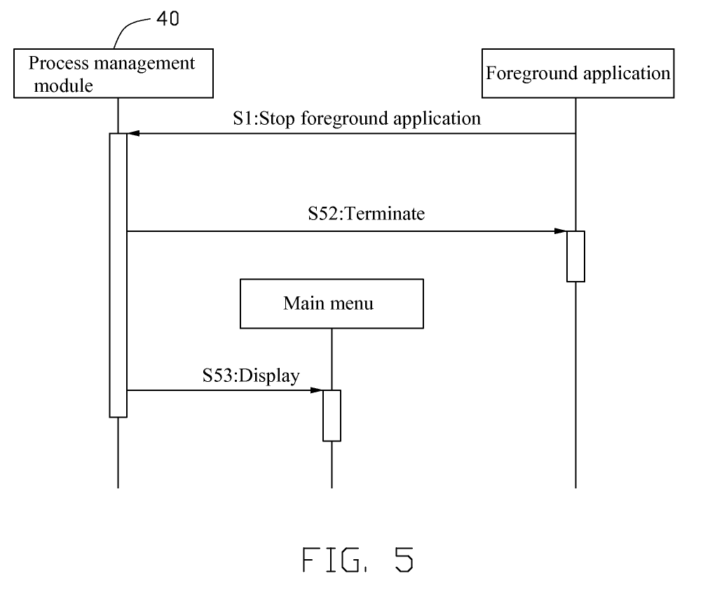

Referring to FIG. 5, when the foreground application is finished, the process for displaying the main menu includes following steps.

In step S51, the foreground application sends an application stop request to the process management module 40.

In step S52, the process management module 40 terminates the foreground application.

In step S53, the process management module 40 displays the main menu on the embedded electronic device 100.

The content acquisition module 60 obtains Internet data for the foreground application module 10. The content acquisition module 60 allows data to be downloaded without interfering with foreground operations.

The Internet streaming daemon module 70 manages the Internet streaming applications, such as acquiring subsequent items in a queue. The playback controller module 80 has an interface for a third party media player providing access to application specific controls such as mute, volume adjustment, file loading, and others. The watchdog module 90 restarts the main menu if the foreground application crashes accidentally, thereby ensuring normal operation of the embedded electronic device 100.

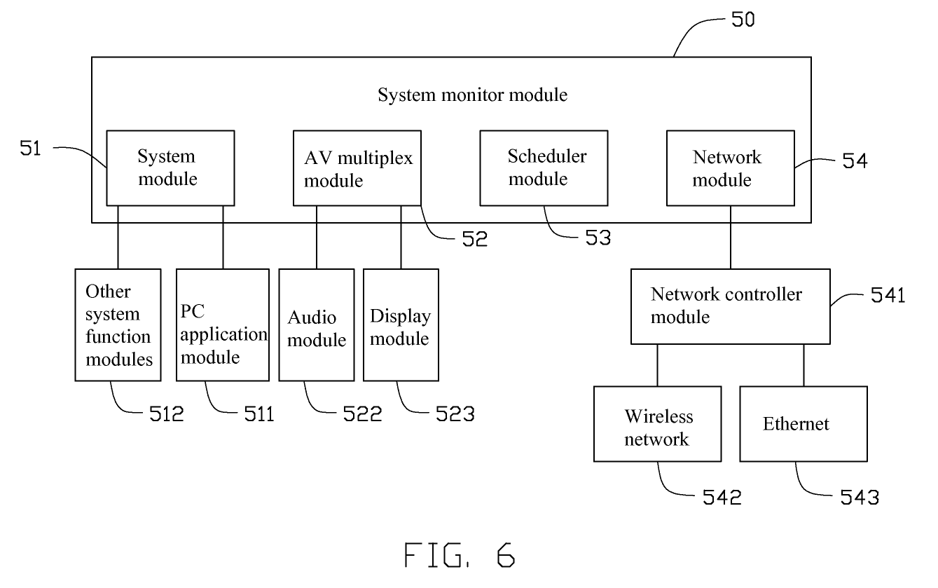

Referring to FIG. 6, the system monitor module 50 includes a system module 51, an audio and video (AV) multiplex module 52, a scheduler module 53, a network module 54, and several system function modules. The several system function modules include an audio module 522, a video module 523, a personal computer (PC) application module 511, and other system function modules 512.

The AV multiplex module 52 is configured to control the audio module 522 and the display module 523. The display module 523 is a Liquid Crystal Display (LCD) display module or a Cathode Ray Tube (CRT) display module. The AV multiplex module 52 controls the output of the audio module 522 by writing Proc files. The AV multiplex module 52 is configured to parse Proc files of the video module 523 to retrieve the current brightness of the video module 523. The AV multiplex module 52 is also configured to write the Proc file to control the brightness.

The system module 51 is configured to monitor the PC application module 511 and the other system function modules 512. The other system function modules 512 includes a touchpad, a G-sensor, a power button, USB devices, real time control (RTC) and so on. The system module 51 is configured to control an LED of the power button by writing Proc files. The system module 51 is configured to detect the current dimension of the device by parsing Proc files of the G-sensor. The system module 51 is configured to determine whether the power button is activated by parsing Proc files of the power button driver, and to control the power LED of the power button by writing Proc files. The system module 51 is configured to query the current system time via the driver ioctl interface. The system module 51 is configured to communicate with the PC application module 511 to accept or reject PC connection request via pipes.

The scheduler module 53 is configured to monitor working statuses of system function modules periodically and transmit the working statuses to the foreground application module 10.

There are message pipes communicating between the foreground application module 10 and the system monitor module 50. The message pipes include an event pipe and a command pipe. The system monitor module 50 transmits information to the foreground application module 10 via the event pipe. The foreground application module 10 transmits commands to the system monitor module 50 via the command pipe.

The network module 54 connects network via a network controller module 541. The network includes wireless network 542 and Ethernet 543.

IP address of the wireless network 542 or the Ethernet 543 for the network controller module 541 is configured by dynamic host configuration protocol (DHCP) module or auto IP module. The DHCP module is configured to allocate IP address for accessing Internet. The auto IP module is configured to allocate IP for accessing other PCs in local area network (LAN). The DHCP module allocates IP preferentially for the network controller module 541. If the DHCP allocates IP unsuccessfully, the AUTO IP allocates IP for the network controller module 541.

Message pipes connect the network controller module 541 and the network module 54. The message pipe includes an event pipe and a command pipe. The network controller module 541 transmits information to the network module 54 via the event pipe. The network module 54 transmits commands to the network controller module 541 via the command pipe.

The commands transmitted from the network module 54 to the network controller module 541, include: reloading the configuration and configuring the network based on the user setting; providing wireless AP list to the system monitor module 50; connecting to AP with specified settings immediately; obtaining IP address, netmask, gateway, and DNS; obtaining current wireless signal level; obtaining current network status (overall connectivity, network type, IP type, Ethernet link status, wireless connected).

Information sent from the network controller module 541 to the network module 54, includes information about DHCP has obtain IP address or failed to get IP address, about when the network cable is plugged or removed, about when the wireless has been disconnected or connected successfully, or about when the wireless signal strength has been changed.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An embedded electronic device, comprising:
a foreground application module;
a system monitor module; and
a network controller module;
wherein the system monitor module is configured to monitor a working status of network via the network controller, the system monitor module is configured to monitor the working status of network and capable of transmitting the working status of the network to the system monitor module, and the system monitor module is capable of sending the working status to the foreground application module.

2. The embedded electronic device of claim 1, wherein the network controller module obtains an IP address, for accessing Internet, and the IP address is configured by a dynamic host configuration protocol (DHCP) module.

3. The embedded electronic device of claim 2, wherein the network controller module obtains a second IP address for accessing other personal computer via an auto IP module.

4. The embedded electronic device of claim 3, wherein the auto IP module is capable of allocating the IP address for the network controller module if the DHCP module allocates the IP address unsuccessfully.

5. The embedded electronic device of claim 1, wherein the system monitor module communicates with the network controller module via message pipes, and the message pipes comprising an event pipe and a command pipe; and the network controller module sends the working status of the network to the system monitor module via the event pipe, and the system monitor module sends commands to the network controller module via the command pipe.

6. The embedded electronic device of claim 1, wherein the network is a wireless network or Ethernet.

7. The embedded electronic device of claim 1, wherein the working status of the network comprises wireless connection and wired connection.

8. The embedded electronic device of claim 1, wherein the working status of the network comprises the status of success or failure of the network controller to obtain an IP address.

9. The embedded electronic device of claim 1, wherein the working status of the network comprises the status of network information sending to the system monitor module according to commands from the system monitor module.

10. The embedded electronic device of claim 9, wherein the network information comprises one of IP address, net mask, gateway, domain name server, and wireless access point list.
